(19) United States
(12) Patent Application Publication
(10) Pub. No.: US 2009/0223185 A1
(43) Pub. Date: Sep. 10, 2009

(54) SPLIT FILTER DRUM

(76) Inventor: Chiu-Po Lin, Taichung City (TW)

Correspondence Address: APEX JURIS, PLLC, 12733 LAKE CITY WAY NORTHEAST, SEATTLE, WA, 98125, US

(21) Appl. No.: 12/044,266

(22) Filed: Mar. 7, 2008

(51) Int. Cl. B01D 39/00

(52) U.S. Cl. 55/307

(57) ABSTRACT

An split filter drum includes a drum body to hold water, a drum lid coupled on an opening of the drum body, an air intake duct which runs through the drum lid and forms a curved discharge portion in the drum body to channel air discharged from a dust collection equipment into the water held in the drum body and enhance blending of dusts, odors, wooden chips and the like with the water, an air outlet located on the drum lid to discharge the air filtered by the water in the drum body, and a water barrier plate to separate the air outlet and an exit opening of the discharge portion. By filtering the air through the water smaller, dusts and odors in the air can be filtered out.

### FIELD OF THE INVENTION

The present invention relates to a split filter drum and particularly to filter drum disposed at a rear side of an air discharge port of a dust collection equipment to remove smaller dusts and odors through water and make air discharged from the dust collection equipment cleaner.

### BACKGROUND OF THE INVENTION

A dust collection equipment is used to collect powders and dusts in an environment to prevent the powders and dusts from wafting around to generate air pollution. It generally is installed in plants that generate powers and dusts during production. For instance, when lumbering mills cut and trim woods or fabricate woods to desired shapes, a great deal of wooded chips and wooden powders are produced. These wooden chips and powders waft in the air and create serious air pollution, and become hazardous to people's health once they are inhaled by people through breathing. They also contaminate environment. Hence lumbering mills usually have a large scale dust collection equipment to attack this problem. The conventional dust collection equipment has a fan driven by a motor. The fan rotates to draw external air into an air intake duct located at an outer side of the dust collection equipment. The air passes through a filter mesh located inside the equipment and impurities in the air can be filtered out. There is a dust collection drum located beneath the dust collection equipment. The dust collection drum holds a plastic bag inside to collect wooden chips, wooden powders and dusts filtered from the air. Furthermore, the air passed through the filter mesh may be channeled into another filter drum to filter out dusts of even smaller sizes through another dust collection bag.

Although a great portion of wooden chips and powders in the air is removed after the air was discharged through the filter mesh or filter drum in the dust collection equipment, the filter mesh and filter drum collect the particulate dusts through a physical mesh structure. Smaller dusts and odors in the air still can pass through the filter mesh and filter drum, and are discharged into the air after treated by the dust collection equipment.

### SUMMARY OF THE INVENTION

Therefore it is an object of the invention to provide a split filter drum to filter air discharged from a dust collection equipment to filter out smaller dusts and odors that have passed through the dust collection equipment.

The split filter drum according to the invention includes a drum body with an opening directing upwards to receive and hold water when in use, a drum lid which has a fastening flange to wedge in the opening of the drum body, an air intake duct running through the drum lid that has a curved discharge portion in the drum body formed at an angle between 90° and 180° to channel air discharged from a dust collection equipment into the water held in the drum body and confined by the inner wall of the drum body, and an air outlet located on the drum lid to discharge the air which has been filtered by the water in the drum body.

The invention further includes a water barrier plate fastened to the bottom surface of the drum lid and extended downwards to the discharge portion to separate the air outlet and an exit opening of the discharge portion so that when the air is discharged through the exit opening of the discharge portion splashing water does not eject out through the air outlet. The water barrier plate has one side bending towards the air intake duct to form a directing curved surface to allow the air discharged from the discharge portion to be filtered by the water and flow along the directing curved surface to the air outlet to be discharged, and other side closely bonding to the drum body to fully block the splashing water and enhance blending of the dusts and wooden chips and the like with the water.

The invention further provides a water blocking plate attached to the bottom surface of the drum lid in front of the water barrier plate and above the discharge portion of the air intake duct to further block the splashing water to provide water barrier function.

Moreover, the drum lid may have a plurality of apertures on an inner rim of the perimeter thereof to increase air discharge from the drum body to reduce water splashing at the air outlet.

The invention provides many benefits, such as by holding the water in the drum body, and separating the air outlet and the exit opening of the discharge portion, the water can filter the air discharged from a dust collection equipment to remove smaller dusts and odors in the air. The air filtered by the split filter drum of the invention is more refreshing without containing the smaller dusts and odors.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view of an embodiment of the invention.

FIG. 2 is an exploded view of an embodiment of the invention.

FIG. 3 is a schematic view of an embodiment of the drum lid from another angle.

FIG. 4 is a plane view of an embodiment of the invention.

FIG. 5 is a perspective view of another embodiment of the invention.

### DETAILED DESCRIPTION OF THE PREFERRED EMBODIMENTS

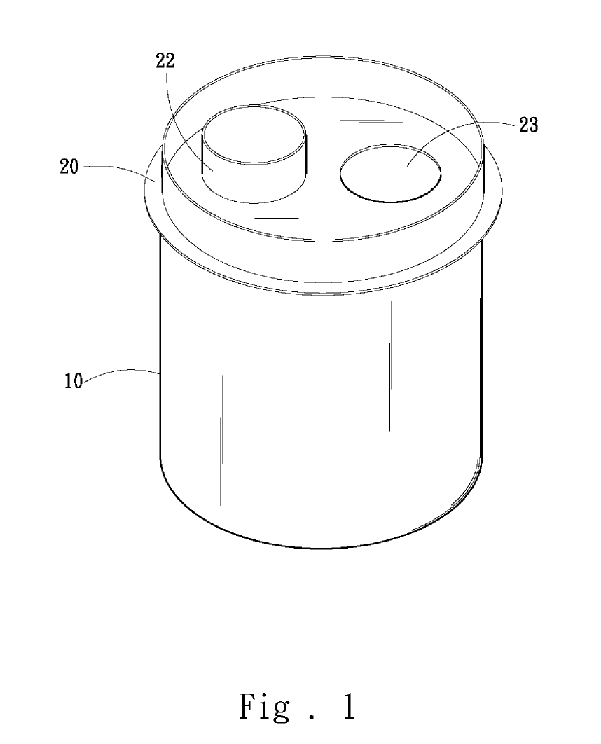

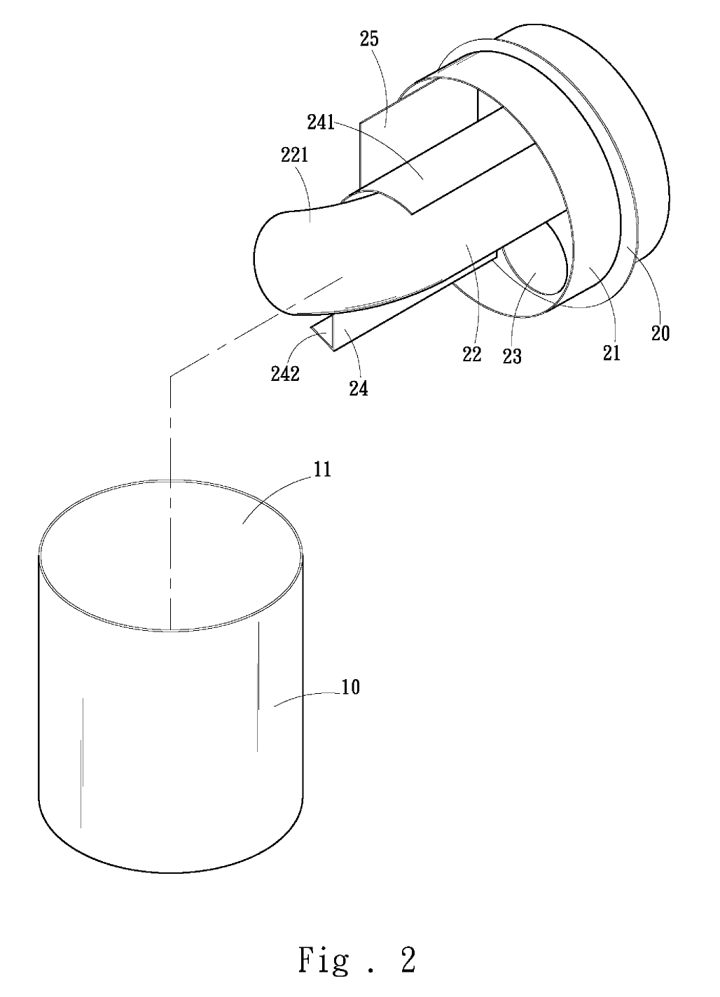

Please refer to FIGS. 1 and 2, the split filter drum according to the invention includes a drum body 10 which has an opening 11 directing upwards to receive and hold water when in use, a drum lid 20 which has a fastening flange 21 at a lower side to be wedge in the opening 11 of the drum body 10 to form a tight coupling.

The drum lid 20 has an air intake duct 22 and an air outlet 23. The air intake duct 22 runs through the drum lid 20 and forms a curved discharge portion 221 inside the drum body 10 to channel air discharged from a dust collection equipment into the water held in the drum body 10. The curved discharge portion 221 forms an angle between 90° and 180° so that the entered air through the air intake duct 22 is confined by the inner wall of the drum body 10. The discharge portion 221 has an exit opening 222 to discharge the air towards the inner wall of the drum body 10 to be filtered by the water. The air outlet 23 discharges the air filtered by the water in the drum body 10.

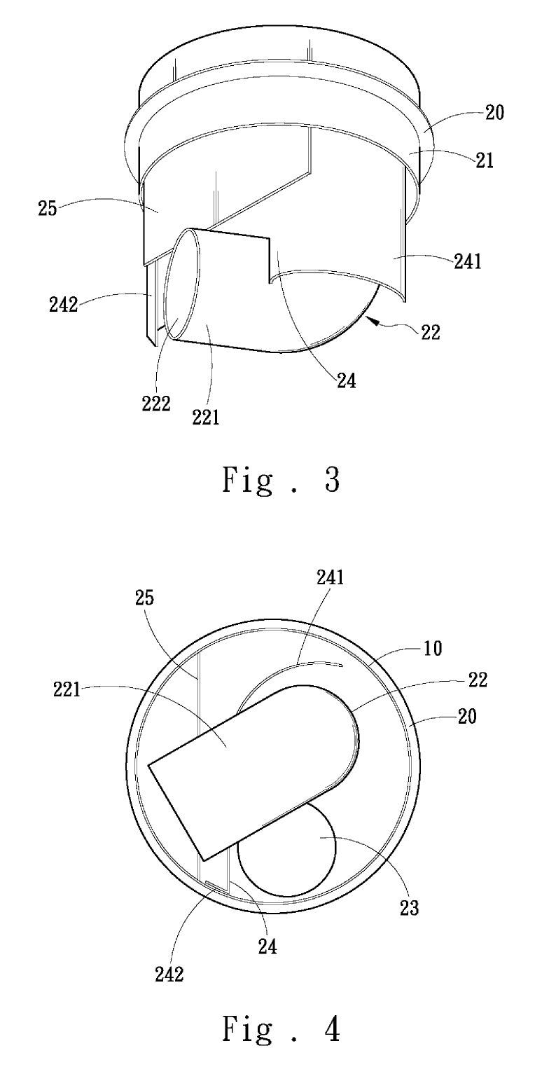

Referring to FIGS. 3 and 4, to prevent the air discharged through the exit opening 222 and hit the inner wall of the drum body 10 from splashing water in the drum body 10, the invention further provides a water barrier plate 24 fastened to the bottom surface of the drum lid 20 and extended downwards until reaching the discharge portion 221 to be anchored there. The air outlet 23 and the exit opening 222 are separated. Hence when the air is discharged through the exit opening 222 splashed water is blocked by the water barrier plate 24 and confined to another area without ejecting outwards through the air outlet 23. The water barrier plate 24 has one side bending towards the air intake duct 22 to form a flow directing curved surface 241. When in use the air discharged through the exit opening 222 is filtered by the water, and clean air flows along the flow directing curved surface 241 to the air outlet 23 to be discharged. The water barrier plate 24 has another side formed a bonding portion 242 to be bonded to the drum body 10 to fully block the splashed water.

The invention further provides a water blocking plate 25 in front of the water barrier plate 24 and fastened to the bottom surface of the drum lid 20 and above the discharge portion 221 to enhance blocking of the splashed water and reduce impact of the water to improve water blocking function.

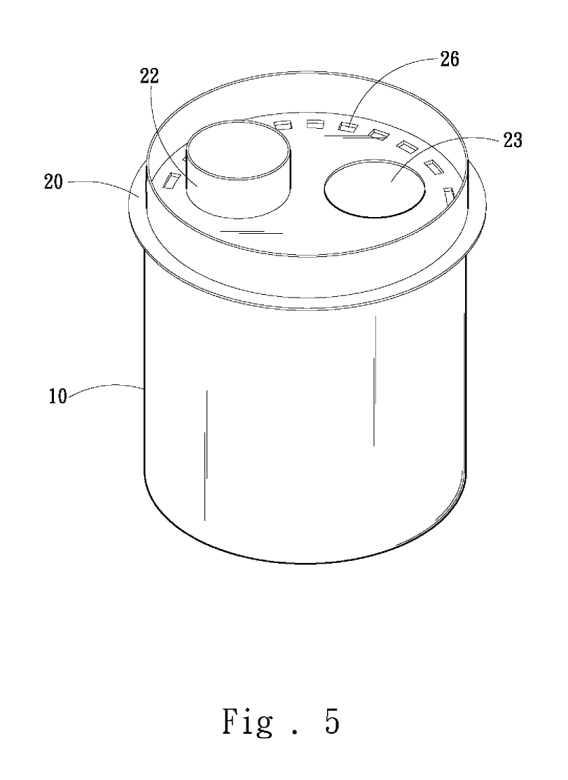

Refer to FIG. 5 for another embodiment of the invention. The drum lid 20 has a plurality of apertures 26 formed on an inner rim adjacent to the perimeter thereof to aid discharge of the air from the drum body 10 in addition to the air outlet 23. Therefore water splashing out through the air outlet 23 can be further reduced during filtering process.

By means of the constructions set forth above, with the discharge portion 221 and air outlet 23 separated, water held in the drum body 10 can filter the air discharged from the dust collection equipment to remove smaller dusts and odors in the air. Air discharged through the air outlet 23 does not contain the smaller dusts and odors. Moreover, the water barrier plate 24 and water blocking plate 25 can block splashed water caused by churning of the air and water. In addition, the water in the drum body 10 can be maintained without losing during operation, and a steady filtering process can be performed as desired.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A split filter drum, comprising:
a drum body having an opening directing upwards to receive and hold water;
a drum lid having a fastening flange at a lower side to be wedged in the opening of the drum body;
an air intake duct running through the drum lid and having a curved discharge portion located in the drum body; and
an air outlet formed on the drum lid.

2. The split filter drum of claim 1, wherein the curved discharge portion forms an angle between 90° and 180°.

3. The split filter drum of claim 1 further having a water barrier plate fastened to the bottom surface of the drum lid and extended downwards to the discharge portion to separate the air outlet and an exit opening of the discharge portion.

4. The split filter drum of claim 3, wherein the water barrier plate has one side bending towards the air intake duct to form a flow directing curved surface and other side bonding to an inner side of the drum body.

5. The split filter drum of claim 3 further having a water blocking plate in front of the water barrier plate that is fastened to the bottom surface of the drum lid and located above the discharge portion.

6. The split filter drum of claim 1, wherein the drum lid has a plurality of apertures formed on an inner rim along the perimeter thereof.
